(19) United States
(12) Patent Application Publication
(10) Pub. No.: US 2026/0166507 A1
(43) Pub. Date: Jun. 18, 2026

(54) PLASMA CYCLONE CALCINATION REACTOR DESIGN

(71) Applicant: SALTX TECHNOLOGY AB, HÄGERSTEN (SE)

(72) Inventors: Corey BLACKMAN, Lidingö (SE); Lars CROON, Stockholm (SE); Boo LJUNGDAHL, Karlskoga (SE)

(21) Appl. No.: 19/124,231

(22) PCT Filed: Oct. 25, 2023
(86) PCT No.: PCT/EP2023/079841

§ 371 Date: Apr. 24, 2025

(30) Foreign Application Priority Data
Oct. 27, 2022 (SE) 2251244-6

(51) Int. Cl. B01J 8/00; B01J 19/00; H05H 1/30; H05H 1/34

(52) U.S. Cl. CPC B01J 8/0055; B01J 19/0013; H05H 1/30; H05H 1/34; B01J 2219/00094; B01J 2219/187

(57) ABSTRACT

There is provided a cyclone reactor design, wherein the reactor comprises an upper part with a first smaller diameter (D1) and a first height (L2), a middle part with a second diameter (D2), and a lower part with a third smaller diameter (D3) and a third height (L4), wherein the directions upper, middle and lower are in relation to the direction of gravity force, wherein the second diameter (D2) is at least 1.25 times larger than the first smaller diameter (D1) and wherein the second diameter (D2) is at least 1.25 times larger than the third smaller diameter (D3), wherein the angles α1 and α2 are in the interval 20°-65°, and wherein the reactor comprises at least one plasma torch, at least one inlet and at least one outlet. Advantages include that the reactor has efficient energy transfer to particles and allows for a compact design.

### TECHNICAL FIELD

The present disclosure relates to a compact cyclone reactor with a plasma torch and a design to maximize the radiation heat transfer as well as a method for heat treating various materials in such a reactor.

### BACKGROUND

Calcination of limestone is a well-known process that has been known for millennia.

US 2012/0141354 discloses a method to separate CO₂ gas generated in a cement-manufacturing facility in a high concentration and recovery of the CO₂ gas. The method includes feeding a cement material before calcination and a heat medium which has a particle diameter larger than that of the cement material and has been heated to the calcination temperature or higher in a medium-heating furnace, to a mixing calciner and recovering the CO₂ gas generated by the calcination of the cement material. The heat medium circulates between the medium-heating furnace and the mixing calciner. One aspect of the present invention includes feeding a cement material before calcination to a regenerative calciner which has been heated to the calcination temperature or higher and has stored heat therein; and recovering the CO₂ gas generated by the calcination of the cement material.

US 2014/0334996 discloses a process for producing a usable product in a reactor comprising introducing co-reactants comprising a fuel source and oxygen into a first section through an inlet, the fuel source comprising carbon; combusting at least a portion of the fuel source and oxygen in an exothermic reaction in the first section using a burner; transferring the co-reactants through a second section that includes a throat having a size that is smaller than a size of the first section, such that a vacuum is induced and a velocity of the co-reactants increases; transferring the co-reactants into a third section that is downstream from the throat and includes an inner wall having a size that is greater than the size of the throat; depositing at least a portion of the uncombusted carbon and a metal oxide along the inner wall, wherein the metal oxide is introduced into at least one of the sections; converting the deposited metal oxide into the usable product in a carbothermic reduction reaction within a molten slag along the inner wall at a temperature of at least 1600° C.

U.S. Pat. No. 4,152,169 discloses calcination in plasma, where the plasma torch rotates. Cyclones are utilized for preheating and subsequent separation, but not in the calcination reactor.

WO 02/096821 discloses a method for calcination with a plasma of carbon dioxide. There is a plasma generator as a separate stage before the calcination reactor. The carbon dioxide gas plasma has a temperature of 3000-4000° C. at the discharge of the plasma generator. The lime raw material is mixed with the hot gas from the plasma generator, i.e., the heat transfer is mainly from the hot gas exiting from the plasma generator. A cyclone is shown in a subsequent step after the calcination reactor. The calcination is not carried out in a cyclone reactor.

WO 2020/232091 discloses calcination where recirculation of gases is utilized. A calcination cyclone stage is disclosed. There is envisaged preheating and heating. The carbon dioxide gas in the calcining loop may be heated up to 2000° C. by an electrical heater. The electrical heater may produce heat via inductive, resistance, infrared, microwave, plasma, or any type based on electrical power. It is clear that the calciner can provide a temperature up to 2000° C. and that this temperature is an upper limit.

US 2012/0263640 discloses a cyclone reactor for producing a usable by-product as part of a recoverable slag layer, the reactor comprising a housing having an outer wall that defines a combustion chamber; an inlet configured to introduce a reactant into the reactor; a burner configured to combust the reactant in a flame zone near a central axis of the chamber; and an outlet configured to provide for the removal of the usable by-product from the housing; wherein the reactor is configured to combust a first portion of the reactant in an exothermic reaction in the flame zone; and wherein the reactor is configured to convert a second portion of the reactant in an endothermic reaction near the outer wall to produce the by-product as part of the slag layer.

US 2010/314788 discloses a system and method for making ultrafine particles. A high temperature plasma is generated at an inlet end of a plasma chamber into which precursor materials are introduced. During operation, a substantially constant pressure and/or material flow pattern is maintained to reduce or eliminate fouling of the system.

US 2010/044477 discloses an apparatus for synergistically combining a plasma with a comminution means such as a fluid kinetic energy mill (jet mill), preferably in a single reactor and/or in a single process step. Within the apparatus potential energy is converted into kinetic energy and subsequently into angular momentum by means of wave energy, for comminuting, reacting and separation of feed materials.

U.S. Pat. No. 6,358,375 discloses a method and a device for the continuous production of carbon black with a high fullerene content. The device essentially consists of a plasma reactor (1), a downstream heat separator (2) to separate the non-volatile constituents and a cold separator (3) attached thereto.

EP 2931849 discloses an apparatus and method that treats matter in a selected temperature range as the matter passes through a first central portion of the first vortex gas flow and exit the second end of the first cylindrical vessel and/or pass through a second central portion of the second vortex flow and exit the fourth end of the second cylindrical vessel.

WO 2014/055574 discloses a multi-mode plasma arc torch that includes a cylindrical vessel having a first end and a second end, a first tangential inlet/outlet connected to or proximate to the first end, a second tangential inlet/outlet connected to or proximate to the second end, an electrode housing connected to the first end of the cylindrical vessel such that a first electrode is (a) aligned with a longitudinal axis of the cylindrical vessel, and (b) extends into the cylindrical vessel, and a hollow electrode nozzle connected to the second end of the cylindrical vessel such that the center line of the hollow electrode nozzle is aligned with the longitudinal axis of the cylindrical vessel.

Even though at least some calcination processes according to the state of the art are successfully used today, there is still room for an improvement with regard to their efficiency and performance. Further, it is desirable to optimize the reactor.

### SUMMARY OF INVENTION

It is an object of the present disclosure to alleviate at least some of the problems in the prior art and to provide an improved heat treatment method as well as a device for carrying out the method.

The inventors have realized that advantages can be obtained by carrying out heat treatment in a cyclone reactor and provide at least one high temperature volume Vₕ, i.e. a plasma torch in the reactor. The high temperature volume Vₕ is a zone in the reactor where the temperature is very high due to a plasma torch, for instance at least 3000° C. In reactors according to the art the heat energy is transferred to the material to be calcined by thermal conduction (at least to some degree), by thermal convection, and by thermal radiation. The inventors have discovered that for material in the form of smaller particles, a more efficient heating can be obtained if the fraction of heat energy transferred by thermal radiation is increased. In particular, this is true for a cyclone reactor, which is compact with a low volume, which gives a short distance between the hot plasma torch in the high temperature zone and the particles to be heat treated. Further, the cyclone reactor can be designed to further, enhance the energy transfer by thermal radiation for instance by prolonging the residence time for the particles at a suitable distance from the high temperature volume Vh. The high temperature zone with its high temperature gives a higher fraction of heat transfer by thermal radiation, which in combination with the compactness of the cyclone reactor gives a very efficient heat transfer to the particles. In the cyclone, the particles swirl around at a suitable distance from the high temperature volume Vₕ i.e., plasma torch, and are thereby heated by thermal radiation to a large extent. If the time at a suitable distance from the high temperature volume Vh is increased the energy transfer by thermal radiation is further improved.

An important advantage is that by having the hot plasma torch in the center of the reactor as seen from above, or at least roughly in the center, the particles whirling around close to the walls of the reactor will protect the walls of the reactor from being exposed to too high temperature, which may otherwise destroy the reactor walls.

The calcination reaction taking place in the whirling particles is actually an endothermic heat sink, which further keeps the temperature at the walls from reaching too high a value. Thereby less expensive materials can be used for the walls of the reactor.

The centrifugal force acting on the particles whirling around in the cyclone reactor in combination with the design of the reactor also contribute to an extended residence time so that the calcination reaction of the particles is completed, while the residence time of the gas is relatively short. Actually, the heat transfer is not the limiting factor, instead it is the reaction kinetics for the calcination reaction of the particles. While keeping the temperature at a suitably high temperature, the calcination reaction takes a certain time to complete to a sufficient degree. This reactor design ensures that the residence time of the particles in a suitable heat radiation is long enough for a calcination reaction to be completed

If the reactor is designed so that the particles will spread out over a larger volume at the suitable distance from the high temperature volume Vh, then the thermal radiation will reach all particles more efficiently, since fewer particles are obstructed by other particles.

The result is quicker heating as well as a more uniform heat transfer to all particles. The fraction of particles, which are not heated immediately in the cyclone, is minimized.

Further, the temperature difference in the process ΔT increases, which also improves the efficiency of the process. Additionally, the elevated temperature of the material leaving the cyclone reactor minimizes spontaneous recombination of the heat-treated products. As an example, for calcination of CaCO₃ the newly formed CaO, does not to any substantial extent, react with released CO₂ to form CaCO₃ before the released CO₂ has been separated from the formed CaO.

Thus, the efficiency is improved, the speed of the calcination can be increased, and the reactor can be made compact.

In a first aspect there is provided a reactor wherein the reactor is a cyclone reactor, wherein the reactor comprises an upper part with a first smaller diameter (D1) and a first height (L2), a middle part with a second diameter (D2), and a lower part with a third smaller diameter (D3) and a third height (L4), wherein the directions upper, middle and lower are in relation to the direction of gravity force, wherein the second diameter (D2) is at least 1.25 times larger than the first smaller diameter (D1) and wherein the second diameter (D2) is at least 1.25 times larger than the third smaller diameter (D3), wherein the first smaller diameter (D1), the second diameter (D2), the third smaller diameter (D3), the first height (L2), and the third height (L4) are selected so that

$$20 ° \leq arctan ( \frac{D 2 - D 1}{2 * L 2} ) \leq 65 °$$

$$20 ° \leq arctan ( \frac{D 2 - D 3}{2 * L 4} ) \leq 65 °$$

and wherein the reactor comprises at least one plasma torch, at least one inlet and at least one outlet.

In a second aspect there is provided a heat treatment method, wherein a material is heat treated in a cyclone reactor, wherein the reactor comprises an upper part with a first smaller diameter (D1) and a first height (L2), a middle part with a second diameter (D2), and a lower part with a third smaller diameter (D3) and a third height (L4), wherein the directions upper, middle and lower are in relation to the direction of gravity force, wherein the second diameter (D2) is at least 1.25 times larger than the first smaller diameter (D1) and wherein the second diameter (D2) is at least 1.25 times larger than the third smaller diameter (D3), wherein the first smaller diameter (D1), the second diameter (D2), the third smaller diameter (D3), the first height (L2), and the third height (L4) are selected so that

$$20 ° \leq arctan ( \frac{D 2 - D 1}{2 * L 2} ) \leq 65 °$$

$$20 ° \leq arctan ( \frac{D 2 - D 3}{2 * L 4} ) \leq 65 °$$

and wherein the reactor comprises at least one plasma torch, at least one inlet and at least one outlet, wherein the material is transported in a swirling gas flow, wherein the material is heated with at least one plasma torch at least by thermal radiation.

Further, embodiments are defined in the appended dependent claims.

Advantages include that the radiation heat transfer to the material is increased. This provides for a very high heat transfer coefficient allowing for the rapid transfer of a large amount of heat to the particles. The heat transfer is affected by having a hot core, i.e. a volume which is hot, which is the plasma torch, where the radiation heat is proportional to T⁴.

Further it is an advantage that more energy can be transferred to the particles because of the extended residence time in the reactor.

The result is a compact reactor, where the residence time of the gases is short, but where the residence time of the particles is much longer. This gives a very efficient process and allows for design of an efficient and compact reactor.

### BRIEF DESCRIPTION OF THE DRAWINGS

Aspects and embodiments will be described with reference to the following drawings in which:

FIG. 1 shows calcination as a function of peripheral temperature in cyclone reactor for example 4.

FIG. 2 shows calcination as a function of peripheral temperature in plasma cyclone reactor for example 5.

FIG. 3 shows calcination as a function of temperature downstream the plasma cyclone reactor for example 6.

FIG. 4 shows a simplified side view of a cyclone reactor. The material is fed pneumatically into the cyclone from the side through a pipe, which is not shown. The diameters of the upper (D1), middle (D2) and lower (D3) parts are shown. Further, the diameter (D4) of the outlet is shown. In this embodiment, the outlet is in the lowermost part of the cyclone reactor. Further, the heights of the different sections are indicated by L1, L2, L3, L4, and L5. The total height of the reactor is L1+L2+L3+L4+L5. The angles of tapered parts of the reactor are indicated with α1 and α2. The angles are between 20° and 65° in relation to a line in the direction of the gravity force, this line is parallel with a center axis of the cyclone reactor.

### DETAILED DESCRIPTION OF THE INVENTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

The term “calcination” as used herein refers inter alia to treatment of limestone (CaCO₃) to yield calcium oxide (CaO). As used herein the term calcination also encompasses thermal treatment of a solid sometimes in absence or limited supply of air or oxygen. Further, treatment of MgCO₃ to yield MgO and treatment of Ca(OH)₂ to yield CaO are also encompassed.

The term “cyclone” as used herein refers to a cyclone reactor where a rotating gas flow is established inside a reactor, which is called a cyclone reactor. The gas including solid material flows in a circular and helical pattern inside the cyclone reactor. Typically, the flow begins in the middle or at the top of the cyclone reactor and typically, the flow ends at the bottom of the cyclone reactor where it exits.

The term “heating” as used herein refers to a process where energy is transferred to a material so that its temperature increases.

The term “sintering” as used herein refers to a process where pieces of solid material form a solid mass by heat without melting the material to liquefaction. The atoms in the material diffuse across the boundaries of the particles, fusing the particles together and creating one solid piece. The sintering temperature does typically not reach the melting point of the material.

The term “plasma” as used herein refers to a fundamental state of matter and is generally described as a gas of ions and free electrons.

In the first aspect there is provided a reactor wherein the reactor is a cyclone reactor, wherein the reactor comprises an upper part with a first smaller diameter (D1) and a first height (L2), a middle part with a second diameter (D2), and a lower part with a third smaller diameter (D3) and a third height (L4), wherein the directions upper, middle and lower are in relation to the direction of gravity force, wherein the second diameter (D2) is at least 1.25 times larger than the first smaller diameter (D1) and wherein the second diameter (D2) is at least 1.25 times larger than the third smaller diameter (D3), wherein the first smaller diameter (D1), the second diameter (D2), the third smaller diameter (D3), the first height (L2), and the third height (L4) are selected so that

$$20 ° \leq arctan ( \frac{D 2 - D 1}{2 * L 2} ) \leq 65 °$$

$$20 ° \leq arctan ( \frac{D 2 - D 3}{2 * L 4} ) \leq 65 °$$

and wherein the reactor comprises at least one plasma torch, at least one inlet and at least one outlet.

The cyclone reactor has a continuous feed of at least one gas together with a continuous or intermittent feed of material in the form of particles to be treated. The inside of the cyclone reactor has a circular cross section and creates a spiral vortex, similar to a tornado. The inlet of gas is in one embodiment, designed to help create the spiral vortex. The particles have some inertia and are affected by gravity force and move downwards to an opening.

Since the cyclone reactor is intended for a whirling spiral vortex inside, the cross section is normally circular. The cross section is taken in a plane perpendicular to the direction of the gravity force.

The upper part, the middle part and the lower part of the reactor are defined in the direction of the gravity, i.e., the directions up and down are in relation to gravity force. This is since the device is intended to work together with gravity force. The upper part, the middle part and the lower part have different diameters, where the middle part has the largest diameter. This implies that the reactor walls in one embodiment, are tapered so that they have a shape as truncated cones. Also, other forms are encompassed, such as ridged, stepped or angled internal walls.

The different parts of the reactor are the following:
The top of the reactor has height L1. In one embodiment, the top of the reactor has a diameter D1, although the top can also have other shapes than a cylindrical cross cut.
The upper part has height L2, also referred to as a first height L2. The upper part has a smallest diameter D1 and connects to the middle part with diameter D2. The smallest diameter D1 is also referred to as first smallest diameter D1. The upper part is typically tapered and thus typically has many different diameters in different crosscuts. The term “smaller diameter” D1 refers to the smallest diameter of the upper part.
The middle part has height L3 and diameter D3. If the middle part has a shape with several different diameters, then the diameter D3 refers to the smallest diameter of the middle part.
The lower part of the reactor has a smaller diameter D3 and connects to the middle part with diameter D2. The diameter D3 is also referred to as the third smaller diameter D3. The lower part has a height L4. The lower part is typically tapered and thus typically has many different diameters in different cross cuts. The term “smaller diameter” D3 refers to the smallest diameter of the lower part.
The lowest part has a height L5 and a diameter D3, and the opening has a diameter D4.

The cyclone reactor comprises at least one plasma torch. Finally, there is also at least one inlet for gas and material in particle form as well as at least one outlet for material and gas.

Because of the larger diameter of the middle part, the particle residence time in this section is prolonged and thereby the material is exposed to thermal radiation for a prolonged time compared to a cylinder-shaped reactor. The relative particle residence time at a suitable distance from the plasma torch is also increased, so that the residence time in other parts of the reactor where the heating is not optimal is minimized.

Because of the larger diameter of the middle part the heat transfer by thermal radiation is facilitated, since the particles in the middle part are spread out at a suitable distance from the plasma torch. Fewer particles will obstruct the direct view to the plasma torch when the particles are spread out in the wider middle part. This effect also facilitates the heat transfer by thermal radiation.

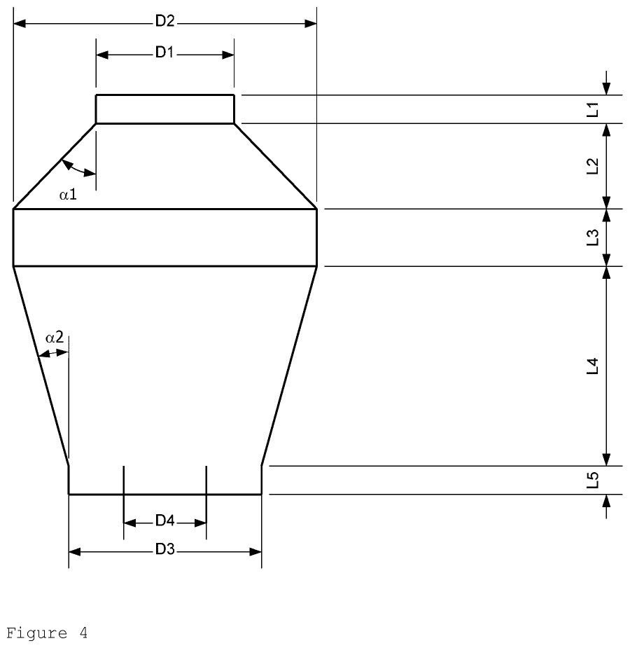

The first smaller diameter (D1), the second diameter (D2), the third smaller diameter (D3), the first height (L2), and the third height (L4) are selected so that the proportions of the upper half and lower half of the reactor are within certain boundaries. When the tapered sections, i.e. the upper part and the lower part are shaped as truncated cones as depicted in FIG. 4, the angles α1 and α2 are defined and are both and independently in the interval 200-65°. The shape of the upper half and the lower half do not have to be truncated cones. For a general shape with the diameters D1, D2, and D3 as well as the heights L2 and L4 the above relations define the proportions. Thus, the tapered parts can have various shapes such as a slightly concave or slightly convex shape. For tapered parts which are not in the shape of a truncated cone it may not be possible to define the angles α1 and α2, but for such shapes the diameters D1, D2, and D3 as well as the heights L2 and L4 define the proportions of those parts.

The relations between the diameters and the heights is important. For the lower half it is important to obtain the correct balance between forces including frictional force against the inner wall of the reactor. In one embodiment, the angle α2 is in the interval 20°-65°. In an alternative embodiment the angle α2 is in the interval 30°-60°. In one embodiment, the lower limit of the angle α2 is the same as the angle of repose for the particles. The angle of repose is measured according to ISO 4324:1977. The lower limit for α2 can be combined with any upper limit such as 60° or 65°.

For the upper half the design and angle is important because it affects how the recirculation of gas is into and to the vicinity of the plasma torch. The design of the upper half affects the probability that particles enter or come too close to the plasma flame in the plasma torch. It is not desirable that the particles enter to plasma flame, since they may be subjected to such a high temperature that they melt or that undesirable side reactions occur. Thus a reactor design which minimizes the probability that a particle enters the plasma flame is desired. This is made by selecting D1, D2, and L2 so that the relation above is fulfilled. In one embodiment, the angle α1 is in the interval 20°-65°. In an alternative embodiment, the angle α1 is in the interval 30°-60°.

In one embodiment, the upper part comprises the shape of a first truncated cone and wherein the lower part comprises the shape of a second truncated cone and wherein angles α1 and α2 are angles of tapered parts of the first truncated cone and the second truncated cone respectively in relation to a line parallel to a center axis of the reactor and wherein α1 and α2 both are in the interval 20°-65°, wherein

$$α 1 = arctan ( \frac{D 2 - D 1}{2 * L 2} )$$

$$α 2 = arctan ( \frac{D 2 - D 3}{2 * L 4} )$$

In one embodiment, the plasma torch is in the upper part. By this design, the thermal radiation from the plasma torch can heat the material which whirls around in the vortex flow in the reactor. Material will, during the extended residence time in the middle part, be exposed to thermal radiation from a plasma torch in the upper part of the reactor.

In one embodiment, the reactor is equipped with at least one inlet in the middle part. By having an inlet in the middle part, the material will have a suitable position within the reactor already on entry. By a tangential inlet in the middle part, the material will have both a suitable position in the reactor and the necessary cyclone will be created. A tangential inlet creates a cyclone. The reactor is designed so that the residence time in the middle is prolonged and in this position the material is heated to a high degree by thermal radiation.

In one embodiment, the reactor is equipped with at least one inlet in an upper half of the reactor. In this embodiment, the gravity will ensure that the particles move to a suitable position for heat treatment and then exiting the reactor.

In one embodiment, at least one inlet is directed tangentially in a circular cross section of the reactor. This will help create a vortex inside the reactor.

In one embodiment, the second diameter (D2) is larger than the sum of the first smaller diameter (D1) and the third smaller diameter (D3).

In one embodiment, the second diameter (D2) is at least 2 times larger than the first smaller diameter (D1) and wherein the second diameter (D2) is at least 1.5 larger than the third smaller diameter (D3).

In one embodiment, the second diameter (D2) and the length L2 create an angle of at least 200 in relation to a line in the direction of the gravity force.

In one embodiment, the second diameter (D2) and the length L4 create an angle of at least 200 in relation to a line in the direction of the gravity force.

In one embodiment, at least one plasma torch is adapted to heat at least one volume (Vₕ) inside the reactor to a temperature of at least 3000° C. The volume around the plasma torch, which is heated, is the volume Vh. Commercially available plasma torches which have a sufficiently high temperature can be used. Many plasma torches are able to reach very high temperatures such as at least 15000° C., at least 20000° C. or at least 25000° C. or even higher, at least in a certain volume, i.e. inside the plasma. However, for this application the temperature of the plasma flame where the flame enters into the cyclone reactor is of relevance. The high temperature of the plasma torch is suitable to give high energy transfer by thermal radiation from the plasma torch to the material in the reactor.

In one embodiment, the reactor is equipped with at least one outlet in the lower half of the reactor. The gravity force will cause the material to be transported downwards and hence it is an advantage to have the outlet in the lower half of the reactor. In one embodiment, the outlet is at the bottom of the reactor.

In one embodiment, at least one inlet for a suspension gas is in the lower part of the reactor. A suspension gas will help to lift the material upwards so that the time in the middle of the reactor is increased. A flow of suspension gas will extend the time where the particles are subjected to efficient thermal irradiation from the plasma torch.

In one embodiment, at least one inlet for a suspension gas is in the lower part of the reactor and wherein at least one inlet for suspension gas is directed upwards in relation to gravity force. The suspension gas helps to lift the particles, in particular if the flow is directed upwards.

In one embodiment, at least one inlet for a suspension gas is in the lower part of the reactor and wherein at least one inlet for suspension gas is directed towards the center of the reactor as seen in a cross section of the reactor, wherein the cross section is perpendicular to the direction of the gravity force.

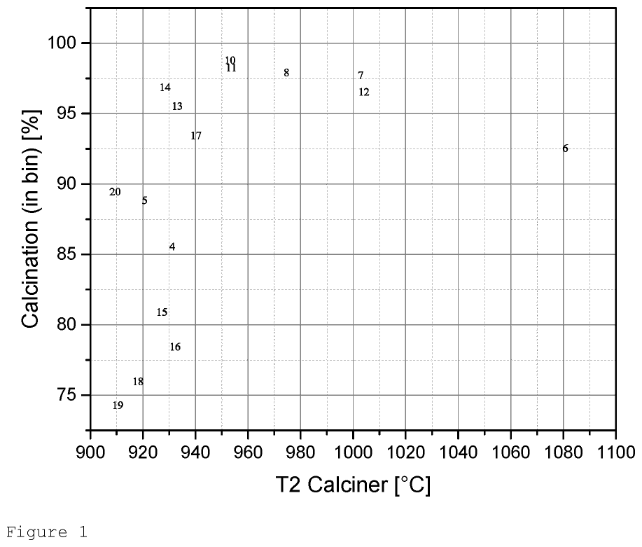

In one embodiment, the height of the reactor has a certain relation to the second diameter D2. In FIG. 1 the height of the reactor is L1+L2+L3+L4+L5. In one embodiment, a height (L1+L2+L3+L4+L5) of the reactor is in the interval D2≤(L1+L2+L3+L4+L5)≤20*D2.

In one embodiment, the reactor is a calcination reactor. In a calcination reactor, a solid material is heated, whereby the temperature of the material is raised to a high temperature, but without melting the material.

In one embodiment, a cooling cyclone is connected in series after at least one outlet from the reactor. Such a system will reduce the temperature of the material quicker, which might be an advantage for some materials and it may also help to use at least some of the heat in the exhaust from the cyclone reactor.

The volume (Vh), which is the volume heated by the plasma torch, is in one embodiment, centred in the cyclone reactor. Since the cyclone reactor has a circular cross section in a plane perpendicular to the direction of the gravity, centered means in the center of such a circle. In one embodiment, the volume (Vh) is in the centre of the vortex of the cyclone, which is intended to be created when the reactor operates. The centre of the vortex during operation is the same as the centre of the cyclone for a typical cyclone with a circular cross section.

The material to treat in the calciner is in one embodiment, CaCO₃ (s). In another embodiment, the material is MgCO₃ (s). In a further, embodiment, the material is CaMg(CO₃)₂ (s) In yet another embodiment, the material is Ca(OH)₂. Alternatively, the material to be treated in the calciner is a mixture comprising at least one of CaCO₃ (s) and MgCO₃. Often CaCO₃ (s) is in the form of calcite having a relatively low melting temperature (1339° C.). However, the CaCO₃ (s) will at normal pressures decompose to CaO at lower temperatures than the melting temperature.

The CaO (s) has a much higher melting temperature (2613° C.). However, the structure of the particle will change at elevated temperature due to phase changes of CaO and impurities. The CaO may also react with various impurities in the raw material. This phenomenon is recognized as “dead burning” when the temperature is excessively high. Thus, too high temperatures are generally to be avoided unless these phase changes are desired. Too high a temperature may occur if a particle enters the plasma flame in the reactor. This is undesirable and the particles should instead whirl around at a suitable distance from the plasma flame.

The material to be treated in the reactor can additionally be heated to temperatures so as to elicit melting, sintering, or other heat induced reactions and/or phase changes.

The material to be heat treated is provided in the form of particles. The particle form ensures that the material can whirl around in the cyclone reactor. If the heat transfer into the interior of the particle and the diffusion resistance of CO₂ leaving the particle is of much less importance than the rate of the calcination reaction, the overall reaction is said to be kinetically controlled. The particles should not be too large and the particles should be sufficiently small so that the reaction rate is kinetically controlled. Further, the heat transfer by radiation is faster and more efficient for smaller particles. Also, adequate particle transport and residence times in the cyclone reactor is made difficult in the case of large particle sizes or with large material aggregates and agglomerates. A particle size in the range 10-1000 μm is suitable, although 5-2000 μm is possible. It is difficult to establish and maintain the desired whirling flow of particles in the reactor if the particles are too large. Thus in one embodiment, the average particle size is lower than 2000 μm, and in another embodiment, the average particle size is lower than 1000 μm. The average particle size is determined as follows. The particle size distribution is measured by laser diffraction according to ISO 13320:2020. Then the average particle size is calculated from the measured particle size distribution as described in ISO 9276-2:2014 using the moment notation. Thus, in one embodiment, the material to be heat treated is provided as particles with an average size in the interval 10 to 1000 μm, wherein the average particle size is calculated according to ISO 9276-2:2014 using the moment notation starting from a particle size distribution measured according to ISO 13320:2020. In one embodiment, the material to be heat treated is provided as particles with an average size in the interval 5 to 2000 μm, wherein the average particle size is calculated according to ISO 9276-2:2014 using the moment notation starting from a particle size distribution measured according to ISO 13320:2020.

The particles are typically carried in a flow of gas when they enter the reactor. The gas is in one embodiment, a mixture of gases. In one embodiment, the mixture of gases comprises CO₂. In one embodiment, the mixture of gases comprises air. In one embodiment, the gas is superheated steam. In one embodiment, inert gases are added in the cyclone reactor. In one embodiment, the cyclone reactor comprises nitrogen gas.

In one embodiment, the plasma comprises at least one selected from the group consisting of carbon dioxide, air, superheated steam, argon, and nitrogen.

The particle residence time in the cyclone reactor is typically in the range of 0.2-60 seconds depending on the desired temperature of the particles, particles size, particle density and other factors. The gas residence time is much shorter. A typical temperature for the particles in the cyclone reactor is in the range 500-1450° C. I.e., the particles reach this temperature after heating. A particle temperature around 1000° C. is utilized in one embodiment. The short residence time in the reactor near the volume Vₕ with high temperature gives a heating to a suitable temperature, mainly by radiant heat transfer from the plasma torch with high temperature. The residence time in the cyclone reactor is adapted so that the particles are heated to a suitable temperature for the calcination reaction to occur. The residence time and the temperature of the particles leaving the calciner are such that the heat-treated material does not undergo chemical recombination with the gas, at least not to any extent which has negative impact on the process. In the prior art it can be a problem that the newly heat-treated material recombines with the released gas. The problem is minimized by keeping the temperature sufficiently high until the reaction products, i.e., the heat-treated material and the released gas are separated from each other. Also, a short processing time after the calcination reaction allowing for rapid separation of the released gas will decrease the problem with recombination.

The particles are in one embodiment, preheated before they are fed to the cyclone reactor.

The volume Vₕ in the cyclone reactor with high temperature is heated with a plasma torch. In one embodiment, the plasma torch comprises an internal electrode, an output electrode, and an insulator between the electrodes, through which the working gas enters the plasma torch. The electric arc is ignited between the two electrodes. Some of the working gas penetrates the arc column while the remaining gas flows between the arc and the wall. The working gas flow, which penetrates the arc column, reaches the temperature of the arc through Joule heating. Joule heating, also known as Ohmic or resistive heating, is described as the heat generated when an electric current pass through a resistance. The gas is ionized and becomes electrically conductive. The rest of the working gas is not heated much since there is no convective heat exchange with the arc due to a thermal boundary layer “blocking” the heat exchange. Where the wall and thermal boundary layers come together, called the shunting zone, the arc and the main gas flow starts interacting, creating intense mixing of the hot and cold gas flows. This results in a plasma flow with a high-temperature core and rapidly decreasing temperature profile in radial direction forming at the exit of the plasma torch. Typically, less than half of the flow participates in the arc discharge and reaches the plasma state, but it is enough to create and maintain the heating element. The remainder of the gas is heated by the plasma via all three mechanisms of heat transfer (conduction, convection, and radiation). Water-cooling of the output electrode is in one embodiment, used to minimize the rate of vaporization of electrode materials due to very high temperatures.

The plasma temperature is held at 3000° C. or more. This temperature is the peak temperature measured at the exit of the plasma torch into the reactor. The temperature in the flame will be gradually lower when the flame expands, because colder gases are mixed in the flame.

The temperature inside the plasma torch is higher compared to the exit of the plasma torch. Inside the plasma the temperature can be considerably higher, but the relevant temperature it at the exit of the plasma torch, where the flame enters the cyclone reactor.

Working gas temperature at inlet to the plasma torch is in one embodiment, limited to 20-150° C., but could also be higher.

In an embodiment where CO₂ is in the plasma torch, hot gases with high energy density are generated by a CO₂-plasma torch. The energy density in such a CO₂-plasma torch is about 4 to 7.5 MJ/kg in a ˜3000-3500° C. torch (with partly dissociated CO₂). The plasma torch is in one embodiment, introduced vertically at the top of the calciner and placed towards the center of the cyclone calciner as seen from the top of the calciner.

The material to be heat treated is in one embodiment, pneumatically conveyed and tangentially introduced into the plasma calciner periphery. This helps to create the vortex inside the cyclone reactor. In one embodiment, the material to be heat treated is fed together with additional CO₂. In one embodiment, the CO₂ flow is preheated. The material to be heat treated is in one embodiment, preheated. In one embodiment, the material to be heat treated is preheated to a temperature in the interval 750-1500° C. In another embodiment the material to be heat treated is preheated to a temperature in the interval 450-1200° C. In yet another embodiment the material to be heat treated is preheated to a temperature in the interval 450-1500° C.

When the material in particle form to be heat treated enters the cyclone calciner, heat is transferred quickly to the particles, partly by thermal radiation but also by mixing and convection. The part of heat transferred by thermal radiation is increased compared to the prior art. This leads to an efficient and rapid calcination and release of additional CO₂.

The reaction is strongly endothermic, and rapidly lowers the average temperature of the particles along the flow of material in the calciner. This lower average temperature of the particles also reduces the exposure of the calciner walls to very high temperatures allowing for cost-effective construction materials to be employed in the design of the cyclone reactor. At the outlet, where both gas and particles are well mixed, the average temperature is in one embodiment, around 900-1300° C. In another embodiment, the average temperature at the outlet is lower.

The particles in the cyclone reactor can be seen as a film of particles in a gas flow and these particles absorb heat from the plasma torch and allow the use of less expensive materials, which are slightly less tolerant to high temperatures.

In one embodiment, the reactor is equipped with at least one outlet in the lower half of the reactor, and the reactor is adapted so that the average temperature of the mixture of gas and particles in the outlet is not more than 1300° C. In one embodiment, the outlet is at the bottom of the reactor. In one embodiment, of the heat treatment method, the material is allowed to be cooled to a temperature of not more than 1000° C. at an outlet of the reactor. The flow of particles is designed so that most of the residence time is in the middle and lower parts of the cyclone reactor. In the lower part of the reactor the heating is less intense since the distance from at least one volume (Vₕ) is greater so that the material is not heated to such a large extent. By having a longer residence time in the lower part of the reactor the temperature at the exit of the reactor is lowered and it has been discovered that this has a positive influence on the calcination.

In one embodiment, at least one volume (Vₕ) is in the uppermost part of the reactor, wherein uppermost is in relation to the direction of gravity force. In a typical embodiment, the material to be heat treated enters the reactor in the top or at least the uppermost part. The material then follows the whirl created inside the cyclone reactor. While the material is in the uppermost part it will be close to the at least one volume (Vₕ) where the temperature is high and there it will be efficiently exposed to thermal radiation. The temperature is so high and due to the choice of a cyclone reactor, the material to be heat treated will be close to the volume (Vₕ) for a short while sufficient for the calcination so that an efficient calcination is ensured. The particles to be heat treated are close to the volume Vₕ for a period of time to reach a suitable temperature for the calcination reaction to occur. The material to be heat treated will flow along the periphery of the cyclone entering from one or several inlets. The flow of particles in a gas flow will form a helical and/or circular gas film in the cyclone. The helical and/or circular flow will allow better control of the process. In one embodiment, the cyclone reactor comprises means to direct the flow of gas and particles. Example of such means include but are not limited to flanges and vanes inside the cyclone reactor.

In one embodiment, the volume (Vₕ) is centered in the cyclone reactor as seen from above and the whirl intended to be created in the cyclone reactor is also centered in the cyclone reactor as seen from above.

All directions such as up, down, side, uppermost, lowermost, and so on are in relation to the intended position of the calciner during operation and in relation to the gravitational force so that down has the same direction as the gravitational force.

In one embodiment, at least one volume (Vₕ) inside the reactor is adapted to be heated by a plasma torch to a temperature of at least 3000° C. In another embodiment, at least one volume (Vₕ) inside the reactor is adapted to be heated by a plasma torch to a temperature of at least 3500° C.

It should be noted that the high temperature at least 3000° C. only applies to the at least one volume (Vₕ) inside the reactor and it does not mean that all material inside the reactor is heated to this temperature. Typically, the residence time inside the reactor for the material to be heat treated is so that this high temperature of 3000° C. is not reached and instead a temperature sufficient for efficient calcination is reached without overheating the particles. Actually the risk for overheating is reduced by the endothermic calcination reaction, which reduces the temperature in a surrounding.

In one embodiment, at least one volume (Vₕ) inside the reactor is heated by the plasma torch to a temperature of at least 3250° C. In one embodiment, at least one volume (Vₕ) inside the reactor is heated by the plasma torch to a temperature in the range 3000-4000° C. In another embodiment at least one volume (Vₕ) inside the reactor is heated by the plasma torch to a temperature in the range 3500-4500° C.

When designing the reactor, it should be considered that, the volume is typically increased due to release of a gas during calcination in general. For the two examples calcination of limestone (CaCO₃) to yield calcium oxide (CaO) and calcination of MgCO₃ to yield MgO, CO₂ is released. The design of the reactor and the surrounding devices should take into account the volume expansion. The design of the reactor with a cyclone near and/or around a plasma torch can give a rapid heating of the material to be heat treated, which in turn gives a rapid reaction with a rapid volume expansion. The designer of the cyclone reactor should take this volume expansion into account by selecting a sufficiently wide diameter of the cyclone reactor.

In one embodiment, the reactor is a calcination reactor. The reactor can be used for heat treating many different materials. The heat treatment can for instance be for the purpose of calcination, sintering or heating the material.

In the second aspect a heat treatment method is provided, wherein a material is heat treated in a reactor, wherein the reactor is a cyclone reactor, wherein the reactor comprises an upper part with a first smaller diameter (D1), a middle part with a second diameter (D2), and a lower part with a third smaller diameter (D3), wherein directions upper, middle and lower are in relation to direction of gravity force, wherein the second diameter (D2) is at least 1.25 times larger than the first smaller diameter (D1) and wherein the second diameter (D2) is at least 1.25 times larger than the third smaller diameter (D3), wherein the material is transported in a swirling gas flow, wherein the material is heated with at least a plasma torch at least by thermal radiation.

The above described cyclone reactor is utilized to perform the method.

In one embodiment, the swirling gas flow is created by the direction of at least one inlet in the reactor. The inlet can for instance be positioned tangentially and rather close to the outer wall of the cyclone reactor to create a whirl inside the cyclone reactor. Other positions of inlets are also possible.

In one embodiment, the plasma torch heats at least one volume (Vh) in the reactor to at least 3000° C.

In one embodiment, the material comprises at least one selected from the group consisting of CaCO₃, MgCO₃, and CaMg(CO₃)₂. In one embodiment, the material comprises Ca(OH)₂. In one embodiment, the material to be heat treated comprises CaCO₃. In another embodiment, the material to be heat treated comprises MgCO₃. In another embodiment, the material to be heat treated comprises Ca(OH)₂. In Further, embodiments, the material to be heat treated comprises at least one of CaCO₃, MgCO₃, Ca(OH)₂, metal oxides, lithium metal oxides, dolomite, kaolinite, clay minerals, clay, minerals, spodumene, iron, nickel, zeolites, cementitious materials, cement raw meal, cement, sand, crushed stone, silicon carbide, silica-based material or mixtures thereof.

In one embodiment, the plasma comprises carbon dioxide. The use of carbon dioxide in the plasma torch gives advantages. The CO₂ in the plasma torch is dissociated into CO, O₂, and O at high temperatures such as 2000° C. The atoms and molecules will be recombined when the temperature drops. This gives a high-energy gas flow, in the order of 4-14 MJ/kg.

In one embodiment, plasma in the plasma torch comprises at least one selected from the group consisting of carbon dioxide, air, superheated steam, argon and nitrogen.

In one embodiment, the material is provided as particles with an average particle in the interval from, 5 to 2000 μm, preferably 10 to 1000 μm, wherein the average particle size is calculated according to ISO 9276-2:2014 using the moment notation starting from a particle size distribution measured according to ISO 13320:2020.

In one embodiment, the material is provided in particles comprising a core, said core comprising the material, said core being coated with an outer layer comprising smaller particles (P_{SMALL}), wherein the smaller particles (P_{SMALL}) have an average particle size in the interval 1-500 nm, wherein the average particle size is calculated according to ISO 9276-2:2014 using the moment notation starting from a particle size distribution measured according to ISO 13320:2020. These coated particles have the advantage of reducing the friction when they are handled. The heat transfer to the core can be moderated by selecting coating material with either good heat conduction properties such as graphene or a material with lower heat conductivity such as SiO₂.

In one embodiment, the smaller particles (P_{SMALL}) comprise at least one material selected from the group consisting of SiO₂, SiO₂ modified by at least one hydrophobic compound, graphite, graphite oxide, graphene oxide, and graphene.

In one embodiment, the material is transported in the swirling gas flow from an inlet and in a direction downwards in the reactor to a point where the swirling flow turns upwards before it turns downwards again to an outlet.

This embodiment lets the material be at a suitable distance from the plasma torch for an extended period of time since the material moves downwards and then turns up and then turns down again. This embodiment further increases the residence time at a suitable distance from the plasma torch for maximum heat transfer by radiation.

In one embodiment, a suspension gas is added in the lower part of the reactor to control particle residence time.

In one embodiment, the material is allowed to be cooled to a temperature of not more than 1400° C. at an outlet of the reactor. In one embodiment, the material is allowed to be cooled to a temperature of not more than 1200° C. at an outlet of the reactor.

In one embodiment, the material is allowed to be cooled to a temperature of not more than 1000° C. at an outlet of the reactor. In one embodiment, the material is allowed to be cooled to a temperature of not more than 800° C. at an outlet of the reactor.

In one embodiment, water is added in the reactor, preferably in gaseous phase. Additionally, water can improve the emissivity and thus heat transfer effectiveness of various plasma gases such as nitrogen, which have lower emissivity compared to many other gases. Thus by the addition of water the plasma torch radiates heat more efficiently.

In one embodiment, the heat treatment is at least one selected from calcination, sintering, and heating.

In one embodiment, the material is cooled by a cooling gas in a cooling cyclone directly after exiting the reactor. This has the advantage that it is possible to recover heat from the process. Further, it is sometimes an advantage with a quick cooling for the treated materials. In one embodiment, the particles are cooled quickly with a cooling gas in a separate mixing chamber after the cyclone reactor.

All embodiments disclosed herein can be freely combined with each other as long as they are not clearly contradictory.

### EXAMPLES

### Example 1

Calcination tests were carried out in a plasma cyclone reactor of diameter 1.25 m and height 1.45 m. The plasma generator of net power 200 kW was placed vertically in the centre of the upper section of the reactor. The temperature in the plasma generator was at least 3000° C. The plasma comprised CO₂. CaCO₃ of average diameter 200 μm was fed tangentially into the plasma cyclone reactor. The degree of calcination of the material was measured for different material outlet temperatures:

| Reactor Outlet | Degree of |
|---|---|
| Temperature | Calcination |
| 1000° C. | 82.1% |
| 1050° C. | 86.7% |
| 1100° C. | 96.2% |

### Example 2

Tests were carried out in a plasma cyclone reactor of diameter 1.25 m and height 1.45 m. The plasma generator of total power 350 kW was placed vertically in the centre of the reactor. Cement raw meal comprising, silica, iron oxide and CaCO₃ of average diameter 8 μm was fed tangentially into the plasma cyclone reactor.

The temperature and throughput of the material were measured:

| Reactor Outlet | Throughput of |
|---|---|
| Temperature | material |
| 1126° C. | 165 kg/h |
| 1212° C. | 50 kg/h |

### Example 3

Tests were carried out in a plasma cyclone reactor of diameter 1.25 m and height 1.45 m. The plasma generator of net power 250 kW was placed vertically in the centre of the reactor. Particles comprising magnesium silicate of average diameter 310 μm was fed tangentially into the plasma cyclone reactor. The temperature and throughput of the material were measured:

| Reactor Outlet | Throughput of |
|---|---|
| Temperature | material |
| 1040° C. | 113 kg/h |
| 1068° C. | 159 kg/h |

### Example 4

Calcination tests were carried out in a cyclone reactor of diameter 1.25 m and height 1.45 m. The plasma generator of net power 265 kW (330 kW gross) was placed vertically in the centre of the upper section of the reactor. The temperature in the plasma generator was at least 3000° C. The energy density of the plasma flame was around 6.2 MJ_{gross}/kg. Limestone particles of 156 μm median diameter were fed tangentially into the plasma cyclone reactor in pure CO₂ atmosphere.

Tests were carried out at different test conditions. In figure below the calcination degree as a function of the measured periphery temperature in the plasma cyclone reactor is plotted. At a temperature more than about 940° C. the degree of calcination was found to be around 97.5%. We refer to FIG. 1.

### Example 5

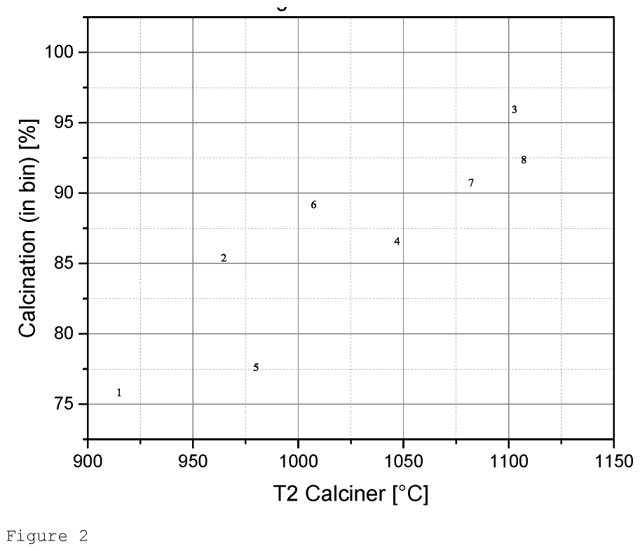

Calcination tests were carried out in a cyclone reactor of diameter 1.25 m and height 1.45 m. The plasma generator of net power 275 kW (340 kW gross) was placed vertically in the centre of the upper section of the reactor. The temperature in the plasma generator was at least 3000° C. The energy density of the plasma flame was around 6.3 MJ_{gross}/kg. Limestone particles of 198 μm median diameter were fed tangentially into the plasma cyclone reactor in pure CO₂ atmosphere. Tests were carried out at different test conditions. In figure below the calcination level as a function of the measured periphery temperature in the plasma cyclone reactor is plotted. Calcination level increases gradually throughout the temperature range. We refer to FIG. 2.

### Example 6

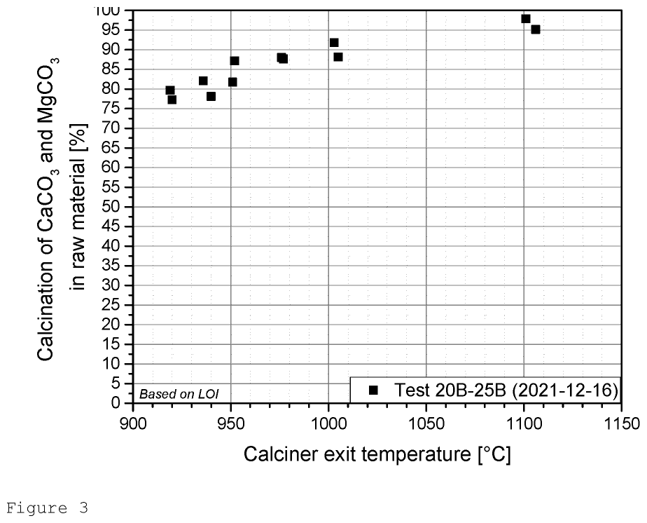

Calcination tests were carried out in a cyclone reactor of diameter 1.25 m and height 1.45 m. The plasma generator of net power 275 kW (340 kW gross) was placed vertically in the centre of the upper section of the reactor. The temperature in the plasma generator was at least 3000° C. The energy density of the plasma flame was around 6.3 MJ_{gross}/kg. Cement raw meal comprising, silica, iron oxide and CaCO₃ of average diameter 8 μm was fed into tangentially into the plasma cyclone reactor in pure CO₂ atmosphere. Tests were carried out at different test conditions. In figure below the calcination level as a function of the measured temperature downstream the plasma cyclone reactor is plotted. Calcination level increases gradually with increasing temperature. We refer to FIG. 3.

1. A reactor wherein the reactor is a cyclone reactor, wherein the reactor comprises an upper part with a first smaller diameter (D1) and a first height (L2), a middle part with a second diameter (D2), and a lower part with a third smaller diameter (D3) and a third height (L4), wherein the directions upper, middle and lower are in relation to the direction of gravity force, wherein the second diameter (D2) is at least 1.25 times larger than the first smaller diameter (D1) and wherein the second diameter (D2) is at least 1.25 times larger than the third smaller diameter (D3), wherein the first smaller diameter (D1), the second diameter (D2), the third smaller diameter (D3), the first height (L2), and the third height (L4) are selected so that
$$20 ° \leq arctan ( \frac{D 2 - D 1}{2 * L 2} ) \leq 65 °$$
$$20 ° \leq arctan ( \frac{D 2 - D 3}{2 * L 4} ) \leq 65 °$$
and wherein the reactor comprises at least one plasma torch, at least one inlet and at least one outlet.

2. The reactor according to claim 1, wherein the upper part comprises the shape of a first truncated cone and wherein the lower part comprises the shape of a second truncated cone and wherein angles α1 and α2 are angles of tapered parts of the first truncated cone and the second truncated cone respectively in relation to a line parallel to a center axis of the reactor and wherein α1 and α2 both are in the interval 20°-65°, wherein
$$α 1 = arctan ( \frac{D 2 - D 1}{2 * L 2} )$$
$$α 2 = arctan ( \frac{D 2 - D 3}{2 * L 4} ) .$$

3. The reactor according to claim 1, wherein the plasma torch is in the upper part.

4. The reactor according to claim 1, wherein the reactor is equipped with at least one inlet in the middle part, wherein the at least one inlet is directed tangentially in a circular cross section of the reactor.

5. The reactor according to claim 1, wherein the reactor is equipped with at least one inlet in an upper half of the reactor, wherein the at least one inlet is directed tangentially in a circular cross section of the reactor.

6. The reactor according to claim 1, wherein the second diameter (D2) is larger than the sum of the first smaller diameter (D1) and the third smaller diameter (D3).

7. The reactor according to claim 1, wherein the second diameter (D2) is at least 2 times larger than the first smaller diameter (D1) and wherein the second diameter (D2) is at least 1.5 larger than the third smaller diameter (D3)

8. The reactor according to claim 1, wherein the at least one plasma torch is adapted to heat at least one volume (Vₕ) inside the reactor to a temperature of at least 3000° C.

9. The reactor according to claim 1, wherein the reactor is equipped with at least one outlet in the lower half of the reactor.

10. The reactor according to claim 1, wherein at least one inlet for a suspension gas is in the lower part of the reactor.

11. The reactor according to claim 1, wherein at least one inlet for a suspension gas is in the lower part of the reactor and wherein the at least one inlet for suspension gas is directed upwards in relation to gravity force.

12. The reactor according to claim 1, wherein at least one inlet for a suspension gas is in the lower part of the reactor and wherein the at least one inlet for suspension gas is directed towards the center of the reactor as seen in a cross section of the reactor, wherein the cross section is perpendicular to the direction of the gravity force.

13. The reactor according to claim 1, wherein a height (L1+L2+L3+L4+L5) of the reactor is in the interval D2≤(L1+L2+L3+L4+L5)≤20*D2.

14. The reactor according to claim 1, wherein the reactor is a calcination reactor.

15. The reactor according to claim 1, wherein a cooling cyclone is connected in series after at least one outlet from the reactor.

16. A heat treatment method, wherein a material is heat treated in a cyclone reactor, wherein the reactor comprises an upper part with a first smaller diameter (D1) and a first height (L2), a middle part with a second diameter (D2), and a lower part with a third smaller diameter (D3) and a third height (L4), wherein the directions upper, middle and lower are in relation to the direction of gravity force, wherein the second diameter (D2) is at least 1.25 times larger than the first smaller diameter (D1) and wherein the second diameter (D2) is at least 1.25 times larger than the third smaller diameter (D3), wherein the first smaller diameter (D1), the second diameter (D2), the third smaller diameter (D3), the first height (L2), and the third height (L4) are selected so that
$$20 ° \leq arctan ( \frac{D 2 - D 1}{2 * L 2} ) \leq 65 °$$
$$20 ° \leq arctan ( \frac{D 2 - D 3}{2 * L 4} ) \leq 65 °$$
and wherein the reactor comprises at least one plasma torch, at least one inlet and at least one outlet,
wherein the material is transported in a swirling gas flow, wherein the material is heated with at least one plasma torch at least by thermal radiation.

17. The heat treatment method according to claim 16, wherein the swirling gas flow is created by the direction of at least one inlet in the reactor.

18. The heat treatment method according to claim 16, wherein the plasma torch heats at least one volume (Vh) in the reactor to at least 3000° C.

19. The heat treatment method according to claim 16, wherein the material comprises at least one selected from the group consisting of CaCO₃, MgCO₃, and CaMg(CO₃)₂.

20. The heat treatment method according to claim 16, wherein the material comprises Ca(OH)₂.

21. The heat treatment method according to claim 16, wherein plasma in the plasma torch comprises at least one selected from the group consisting of carbon dioxide, air, superheated steam, nitrogen and argon.

22. The heat treatment method according to claim 16, wherein the material is provided as particles with an average particle size in the interval from, 5 to 2000 μm, preferably 10 to 1000 μm, wherein the average particle size is calculated according to ISO 9276-2:2014 using the moment notation starting from a particle size distribution measured according to ISO 13320:2020.

23. The heat treatment method according to claim 16, wherein the material is provided in particles comprising a core, said core comprising the material, said core being coated with an outer layer comprising smaller particles (P_{SMALL}), wherein the smaller particles (P_{SMALL}) have an average particle size in the interval 1-500 nm, wherein the average particle size is calculated according to ISO 9276-2:2014 using the moment notation starting from a particle size distribution measured according to ISO 13320:2020.

24. The heat treatment method according to claim 23, wherein the smaller particles (P_{SMALL}) comprise at least one material selected from the group consisting of SiO₂, SiO₂ modified with at least one hydrophobic compound, graphite, graphite oxide, graphene oxide, and graphene.

25. The heat treatment method according to claim 16, wherein the material is transported in the swirling gas flow from an inlet and in a direction downwards in the reactor to a point where the swirling flow turns upwards before it turns downwards again to an outlet.

26. The heat treatment method according to claim 16, wherein a suspension gas is added in the lower part of the reactor.

27. The heat treatment method according to claim 16, wherein the material is allowed to be cooled to a temperature of not more than 1400° C. at an outlet of the reactor.

28. The heat treatment method according to claim 16, wherein water is added in the reactor, preferably in gaseous phase.

29. The heat treatment method according to claim 16, wherein the heat treatment is at least one selected from calcination, sintering, and heating.

30. The heat treatment method according to claim 16, wherein the material is cooled in a cooling cyclone directly after exiting the reactor.
